(19) United States
(12) Patent Application Publication
(10) Pub. No.: US 2017/0173608 A1
(43) Pub. Date: Jun. 22, 2017

(54) ELECTROSTATIC SPRAY GUN HAVING EXTERNAL CHARGE POINTS

(71) Applicant: Graco Minnesota Inc., Minneapolis, MN (US)

(72) Inventor: Geoffrey A. BULLOCK, Jordan, MN (US)

(21) Appl. No.: 15/301,502

(22) PCT Filed: Mar. 30, 2015
(86) PCT No.: PCT/US2015/023311

§ 371 Date: Oct. 3, 2016

Related U.S. Application Data
(60) Provisional application No. 61/975,225, filed on Apr. 4, 2014.

(51) Int. Cl. B05B 5/053

(52) U.S. Cl. CPC B05B 5/0535

(57) ABSTRACT

An electrostatic spray apparatus includes an electrostatic spray gun having a first external surface and a second external surface. A first electrode is disposed on the first external surface and is configured to ionize a material and to generate a first electrical field between the first electrode and a grounded object. A second electrode is disposed on the second external surface of the apparatus and is configured to generate a second electric field between the second electrode and the grounded object.

### BACKGROUND

Electrostatic spray guns are used to spray a coating such as paint onto a grounded object. Electrostatic spray guns typically pass an electrical charge through the gun. If a grounded object is brought too close to the electrostatic spray gun, there can be a risk of creating an arc between the spray gun and a grounded object. This is undesirable because the coating that is being sprayed by the spray gun can be flammable and can be ignited by an arc.

Grounded objects can approach the electrostatic spray gun from many directions. The electrostatic spray gun may not be able to detect objects approaching from every direction. That is, grounded objects can approach the electrostatic spray gun from a blind spot relative to the spray gun. There is, accordingly, a need for an electrostatic spray gun that substantially eliminates blind spots and can detect a grounded object approaching the gun spray from substantially any direction.

### SUMMARY

In one embodiment according to this disclosure an electrostatic spray apparatus includes an electrostatic spray gun having a first external surface and a second external surface. A first electrode is disposed on the first external surface and is configured to ionize a material and to generate a first electrical field between the first electrode and a grounded object. A second electrode is disposed on the second external surface of the apparatus and is configured to generate a second electric field between the second electrode and the grounded object.

In yet another embodiment according to this disclosure an electrostatic spray gun includes a barrel having a front surface, a first side surface, and a second side surface. The gun further includes a first needle electrode projecting at least partially from the front surface of the barrel. An air cap is attached to the front surface of the gun and is configured to dispense paint droplets near the first needle electrode. The gun further includes a second electrode projecting at least partially from the first side surface of the barrel. The gun still further includes a third electrode projecting at least partially from the second side surface of the barrel.

### BRIEF DESCRIPTION OF THE DRAWINGS

FIG. 1 is a side plan view of an electrostatic spray apparatus having a first electrode disposed on a front surface of an electrostatic spray gun and a second electrode disposed on a side surface of the spray gun.

FIG. 2 is a top plan view of the electrostatic spray gun showing the first electrode on the front surface of the spray gun, the second electrode disposed on the side surface of the gun and a third electrode disposed on another side surface of the spray gun.

FIG. 3 is a partial cross-sectional view the electrostatic spray gun.

FIG. 4 is a side plan view of the second electrode.

### DETAILED DESCRIPTION

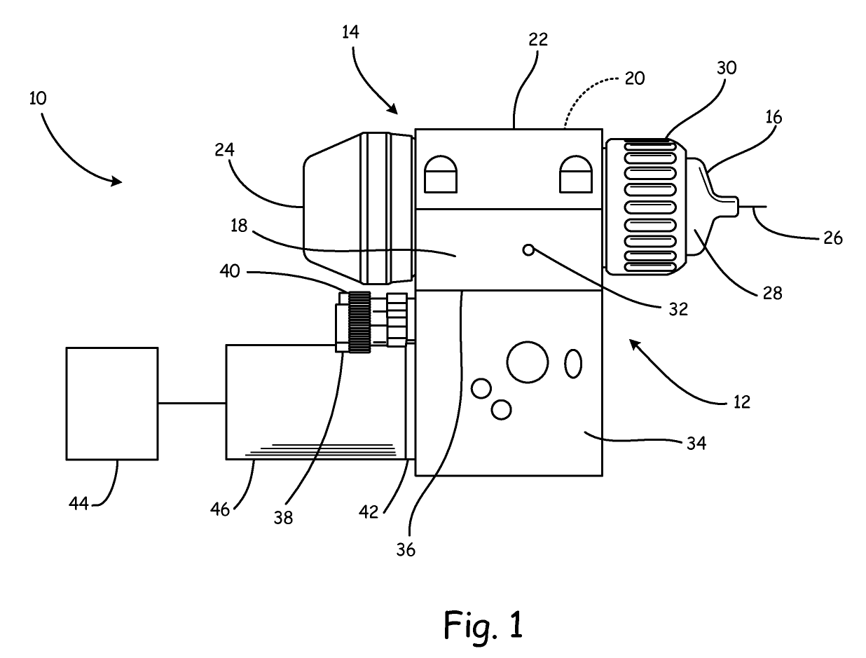

FIG. 1 is a side plan view of electrostatic spray apparatus 10. Electrostatic spray apparatus 10 includes electrostatic spray gun 12. Electrostatic spray gun 12 includes barrel 14, which includes front surface 16, first side surface 18, second side surface 20, third side surface 22, and back surface 24. Electrostatic spray gun 12 also includes first electrode 26, air cap 28, retaining ring 30, and second electrode 32. Electrostatic spray gun 12 further includes, mount block 34, joint 36, air fitting 38, spray fitting 40, and charge multiplier 42. Controller 44 is part of electrostatic spray apparatus 10 and is also shown in FIG. 1. Mechanical device 46 is also shown.

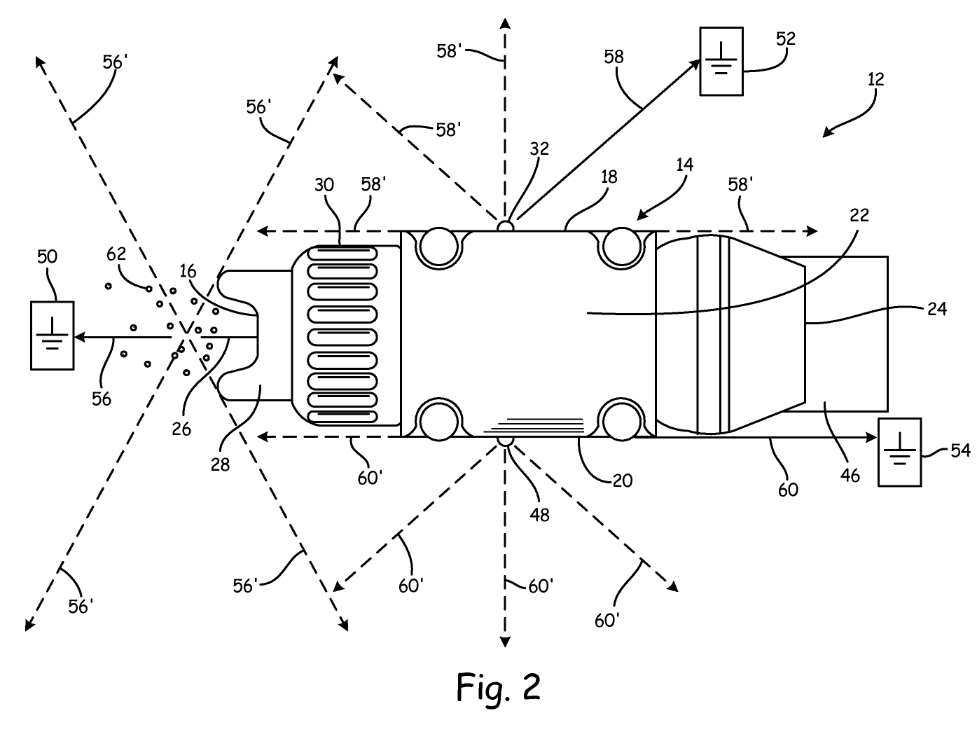

As shown in FIG. 1, first side surface 18 is flat and defines a side of barrel 14. Second side surface 20 minors first side surface 18 and is shown in FIG. 2. Third side surface 22 spans between first side surface 18 and second side surface 20. As shown, third side surface 22 has an arcuate contour but could also be flat in other embodiments. Back surface 24 is disposed on an opposite side of barrel 14 relative to front surface 16. First electrode 26 is a needle electrode and projects from front surface 16. Air cap 28 is secured to front surface 16 by retaining ring 30. Second electrode 32 projects from first side surface 18.

Barrel 14 is mounted to mount block 34. Joint 36 is formed at the interface of barrel 14 and mount block 34. Air fitting 38 and spray fitting 40 are attached to mount block 34. Charge multiplier 42 is also attached to mount block 34. Controller 44 is connected to charge multiplier 42. Mount block 34 attaches electrostatic spray gun 12 to mechanical device 46, which can be a robotic arm that can move electrostatic spray gun 12 during operation.

FIG. 2 is a top plan view of electrostatic spray gun 12. Electrostatic spray gun 12 includes second side surface 20 and third electrode 48. FIG. 2 also shows first grounded object 50, second grounded object 52, third grounded object 54, first electric field 56, second electric field 58, third electric field 60, and ionized paint droplets 62. Additional electric fields 56′, 58′, and 60′ can be formed, depending on the location of the grounded object, and are shown with dashed lines.

As shown in FIG. 2, third electrode 48 projects from second side surface 20. Other embodiments of electrostatic spray gun 12 can include further electrodes in addition to first electrode 26, second electrode 32, and third electrode 48. As shown in FIG. 2, second electrode 32 and third electrode 48 are disposed on generally opposite sides of barrel 14. But in other embodiments, second electrode 32 and third electrode 48 can be disposed at any other location along barrel 14 relative to each other. For example, second electrode 32 can be disposed on first side surface 18 and third electrode 48 can be disposed on third surface face 22 or back surface 24.

First grounded object 50, second grounded object 52, and third grounded object 54, are positioned around electrostatic spray gun 12. First electric field 56 is generated between first electrode 26 and first grounded object 50. Second electric field 58 is generated between second electrode 32 and second grounded object 52. Third electric field 60 is generated between third electrode 48 and third grounded object 54. Paint droplets are dispensed from air cap 28 and ionized by first electrode 26. Ionized paint droplets 62 are shown traveling towards first grounded object 50 to coat it with ionized paint droplets 62.

In operation, a charge is supplied to parts of electrostatic spray gun 12. The charge is produced by controller 44. Controller 44 is connected to electrostatic spray gun 12. Controller 44 generates charge such that a difference in electrical potential between electrostatic spray gun 12 and the ground ranges from about 5 volts to about 15 volts. The charge is passed to charge multiplier 42 and increased. Charge multiplier 42 is part of electrostatic spray gun 12. Charge multiplier 42 increases the difference in electrical potential between electrostatic spray gun 12 and the ground to a value ranging from about 20 kilovolts (kV) to about 150 kV. The specific charge produced by charge multiplier 42 can depend on whether electrostatic spray gun 12 is an automatic electrostatic spray gun or a handheld electrostatic spray gun.

As depicted in FIGS. 1 and 2, electrostatic spray gun 12 is an automatic electrostatic spray gun. Automatic electrostatic spray guns are configured to be joined to a mechanical device, such as mechanical device 46 that moves electrostatic spray gun 12 about an object to be coated. Mount block 34 can be used to join electrostatic spray gun 12 to device 46. Automatic electrostatic spray guns can also be programed to control the amount of spray that is dispensed by electrostatic spray gun 12. Handheld electrostatic spray guns are manually operated by a human operator and usually have a trigger that allows the operator to control the flow of paint droplets 62. Automatic electrostatic spray guns are typically provided with a charge producing a difference in electrical potential between electrostatic spray gun 12 and the ground at or exceeding 100 kV whereas handheld electrostatic spray guns are typically provided with a charge producing a difference in electrical potential at or below 85 kV.

The charge produced by charge multiplier 42 is provided to first electrode 26, second electrode 32, and third electrode 48. The charge produced by charge multiplier 42 also produces a charge at locations between charge multiplier 42 and each electrode 26, 32, and 48. Those locations include mount block 34, joint 36, and barrel 14.

A supply of air and paint used to coat first grounded object 50 are provided to electrostatic spray gun 12 from external sources. Air fitting 38 receives the air and spray fitting 40 receives the paint. Air and paint are routed through mount block 34 to barrel 14. Air and paint are dispensed from air cap 28 to a location near first electrode 26. The paint is ionized by first electrode 26 through a process known as corona charging. In corona charging, a pointed electrode, such as the needle electrode representing first electrode 26, is supplied with a charge from charge multiplier 42 as discussed above. This creates an intense electrical field at first electrode 26 which breaks down the surrounding air molecules and creates ions which attach themselves to the paint droplets 62. First electric field 56 also helps drive ionized paint droplets 62 to first grounded object 50, which causes a greater percentage of ionized paint droplets 62 to reach first grounded object 50, rather than miss first grounded object 50 or be swept away by surrounding air flow.

Electrostatic spray gun 12 can be configured to move in order to better coat first grounded object 50. That is, electrostatic spray gun 12 can move towards or away from first grounded object 50, up or down, or sideways across the surface of first grounded object 50. Alternatively, electrostatic spray gun 12 can be stationary and first grounded object 50 can move relative to electrostatic spray gun 12.

First electrode 26, second electrode 32, and third electrode 48 are all configured to create an electric field with a grounded object. As discussed further below, creating an electric field between one of electrodes 26, 32, or 48 and a grounded object can help to prevent an arc from forming between electrostatic spray gun 12 and the grounded object if the two are close enough to pose a risk of forming an arc. The distance that the two can be from each other where there is a risk of forming an arc depends on the charge provided to electrostatic spray gun 12. As a non-limiting example, if electrostatic spray gun 12 is provided with a charge producing a difference in electrical potential between electrostatic spray gun 12 and the ground of about 100 kV, then a distance between electrostatic spray gun 12 and a grounded object ranging from about 5 inches apart (127 millimeters) to about 7 inches apart (177 millimeters) can create a risk of an arc forming.

If an electric field is formed between one of electrodes 26, 32, or 48 and a grounded object, then air molecules therebetween can be ionized. The ionization of the air molecules is actively controlled in that a charge is constantly supplied to electrodes 26, 32, and 48 by controller 44 and charge multiplier 42. Ionization of the air molecules between electrodes 26, 32, or 48 and the grounded object decreases the difference in electrical potential between electrostatic spray gun 12 and the grounded object. Decreasing the difference in electrical potential between electrostatic spray gun 12 and the grounded object lowers the risk of a rapid discharge of electricity between the two objects. Thus, the risk of forming an arc is lowered.

If electrostatic spray gun 12 and the grounded object continuously draw nearer to each other, the ionization caused by the electrical field between the two will continue to decrease the difference in electrical potential between electrostatic spray gun 12 and the grounded object to the point where the difference will be at or near zero volts. More specific examples showing first electrode 26, second electrode 32, and third electrode 48 interacting with first grounded object 50, second grounded object 52, and third grounded object 54, respectively are discussed below.

As shown in FIG. 2, first electrode 26 is located on barrel 14 at front surface 16. First electrode 26 can form first electric field 56 between itself and first grounded object 50. Additionally, first electrode 26 can form an electric field between itself and essentially any grounded object that approaches front surface 16. However, front surface 16 blocks the formation of an electric field with respect to a grounded object and first electrode 26 approaching first side surface 18 or second side surface 20. This is due to front surface 16, from which first electrode 26 extends, being perpendicular to first side surface 18 and second side surface 20. For example, FIG. 2 shows second grounded object 52 and third grounded object 54 which are disposed at a location near first side surface 18 and second side surface 20, respectively, where an electric field cannot be formed between first electrode 26 and second grounded object 52 or third grounded object 54. Thus, second grounded object 52 and third grounded object 54 are located in a “blind spot” relative to first electrode 26. To demonstrate this, some of the possible electric fields that first electrode 26 can form are illustrated with dashed lines as additional electric fields 56′ in FIG. 2.

FIG. 2 also shows second electrode 32 located on barrel 14 at first side surface 18. Second electrode 32 can form second electric field 58 between itself and second grounded object 52. Additionally, second electrode 32 can form an electric field between itself and essentially any grounded object that approaches second side surface 20 and third side surface 22. An electric field can be formed around third side surface 22 because third side surface 22, as shown, has an arcuate contour and an electric field can extend around a portion of it. Second electrode 32 can also create an electric field between itself and some grounded objects approaching front surface 16 because an electric field can be projected parallel to first side surface 18. Some of the possible electric fields that second electrode 32 can form are illustrated with dashed lines as additional electric fields 58′ in FIG. 2. As shown in FIG. 1, second electrode 32 is positioned at a location proximate to joint 36 to allow second electrode 32 to form an electric field between itself and a grounded object approaching joint 36.

FIG. 2 also shows third electrode 48 located on barrel 14 at second side surface 20. Third electrode 48 can form third electric field 60 between itself and third grounded object 54. Additionally, third electrode 48 can form an electric field between itself and essentially any grounded object that approaches second side surface 20 and third side surface 22. An electric field can be formed around third side surface 22 because third side surface 22, as shown, has an arcuate contour and an electric field can extend around a portion of it. Third electrode 48 can also create an electric field between itself and some grounded objects approaching front surface 16 because an electric field can be projected parallel to second side surface 20. Some of the possible electric fields that third electrode 48 can form are illustrated with dashed lines as additional electric fields 60′ in FIG. 2. Third electrode 48 is positioned on second side surface 20 at a location substantially opposite from second electrode 32. Thus, third electrode 48 is also positioned proximate to joint 36 to allow an electric field between itself and a grounded object approaching joint 36. If it is possible that a grounded object would approach back surface 24, then electrode 26, 32, or 48 can be placed on that surface without departing from the scope of this invention. Similarly, electrode 26, 32, or 48 can be placed on third surface 22 if necessary.

The examples discussed above describe instances where each electrode interacts with a different grounded object. It is also contemplated that a grounded object could approach electrostatic spray gun 12 from a direction where two or more electrodes can produce an electric field with the object. This is because there are several locations where electric fields from the electrodes can overlap. It is also possible that two electrodes can form an electric field between different portions of the same grounded object.

As stated above, first electrode 26, second electrode 32, and third electrode 48 can help to prevent arc formation by allowing ionization to occur between one of the electrodes and a grounded object. Additional measures can be taken to help prevent arc formation as well. For example, controller 44 can be programed to detect a drop in the difference in electrical potential between first electrode 26, second electrode 32, or third electrode 48 and the ground. A drop in the electrical potential like this can be an indicator that a grounded object is drawing near electrostatic spray gun 12. Controller 44 can be additionally programed to shut down electrostatic spray gun 12 if controller 44 detects that the rate of change of a difference in electrical potential between first electrode 26, second electrode 32, or third electrode 48 and the ground exceeds a programed threshold rate of change.

Another measure that can be taken to prevent arc formation in addition to using first electrode 26, second electrode 32, and third electrode 48 as described above can be to provide dielectric shielding at certain locations in electrostatic spray gun 12. Dielectric shielding involves using mechanical means to prevent electricity from going to an undesired location. For example, electrical components, such as wires, can be surrounded by an insulative material. Some methods include surrounding the electrical components of electrostatic spray gun 12 with concentric rings of insulative material or coating the electrical components with dielectric grease such as a silicone based greases. Joint 36 can also be coated with dielectric grease.

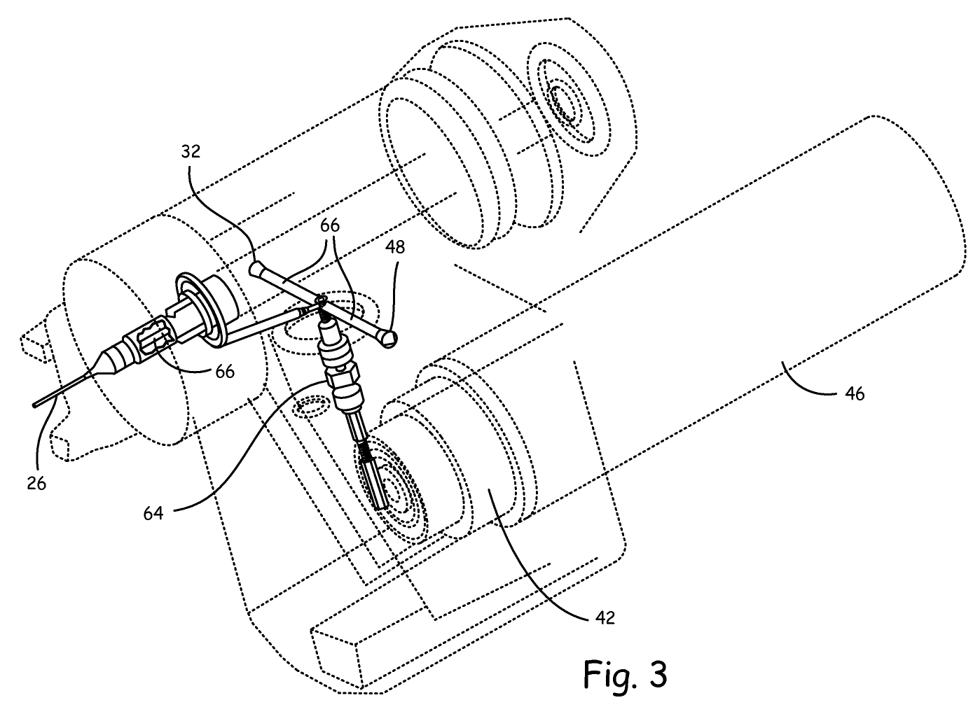

FIG. 3 is a partial cross-sectional view of electrostatic spray gun 12. FIG. 3 includes circuit components 64 and resistors 66. As shown in FIG. 3, charge multiplier 42 is disposed within electrostatic spray gun 12. Circuit components 64 are made from a conductive material and connect to resistors 66. Resistors 66 connect to each of first electrode 26, second electrode 32, and third electrode 48.

In operation, charge multiplier 42 increases the charge provided by controller 44 as stated previously. The charge is carried through circuit components 64 and resistors 66 and into first electrode 26, second electrode 32, and third electrode 48.

Resistors 66 cause the voltage at each electrode to be less than the charge produced at charge multiplier 42. For example if charge multiplier 42 produces a charge where the difference in electrical potential between electrostatic spray gun 12 and the ground is about 100 kV, then the difference in electrical potential between each electrode and the ground can be about 80 kV.

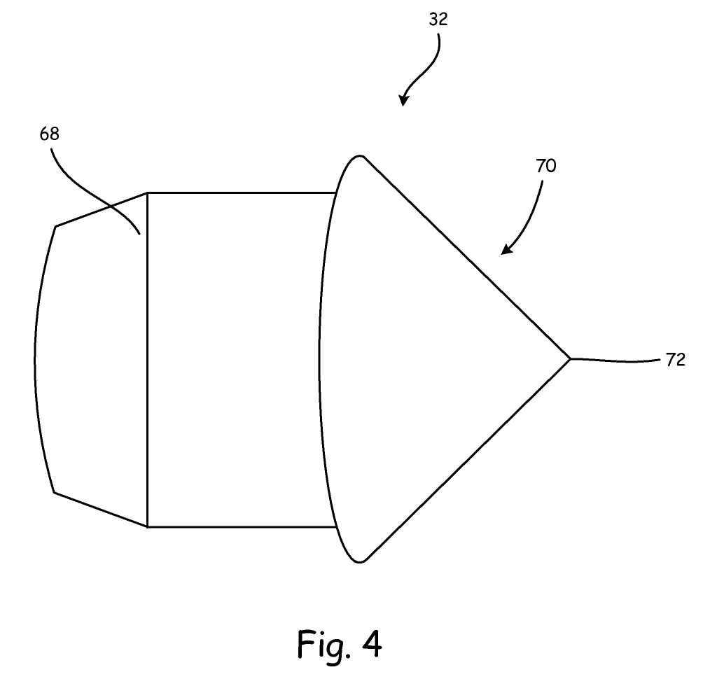

FIG. 4 is a side plan view of second electrode 32. Second electrode 32 includes base 68, and outer surface 70. Outer surface 70 includes ionizing tip 72. Base 68 is cylindrically shaped. Outer surface 70 is conically shaped. The diameter of outer surface 70 is greatest near base 68. The diameter of outer surface 70 decreases gradually to form ionizing tip 72 as outer surface 70 extends outwardly from base 68.

In operation, base 68 is disposed within second side surface 20 of barrel 14 and outer surface 70 projects from second side surface 20. A charge is supplied to second electrode 32 which ionizes the air around ionizing tip 72. Third electrode 48 can be configured to be substantially the same as second electrode 32. Second electrode 32 differs from first electrode 26 in that second electrode 32 is not a needle electrode. This is because the needle shape of first electrode 26 can help to ionize paint droplets 62. Because second electrode 32 and third electrode 48 do not ionize paint droplets 62 it is not necessary for them to have a needle shape.

There are many reasons to use electrostatic spray apparatus 10 including the following non-limiting reasons. For example, positioning first electrode 26, second electrode 32, and third electrode 48 around electrostatic spray gun 12, gives electrostatic spray gun 12 the ability to create an electric field between itself and a grounded object approaching it from substantially any direction. This means ionization can occur between a grounded object and the electrodes of electrostatic spray gun 12 regardless of the direction from which the grounded object approaches.

Another reason to use electrostatic spray apparatus 10 is that positioning second electrode 32 or third electrode 48 near joint 36 can be helpful to eliminate arcing at joint 36. When a charge passes by a jointed surface such as joint 36 between barrel 14 and mount block 34 arcs can be created. Therefore, disposing second electrode 32 and third electrode 48 at a location proximate to joint 36 as described above can help prevent the risk of arcing between joint 36 and a grounded object.

Although the present invention has been described with reference to preferred embodiments, workers skilled in the art will recognize that changes may be made in form and detail without departing from the spirit and scope of the invention.

1. An electrostatic spray apparatus comprising:
an electrostatic spray gun having a first external surface and a second external surface;
a first electrode disposed on the first external surface and configured to ionize a material and to generate a first electric field between the first electrode and a grounded object; and
a second electrode disposed on the second external surface of the apparatus and configured to generate a second electric field between the second electrode and a grounded object.

2. The electrostatic spray apparatus of claim 1, wherein the material is a droplet of paint.

3. The electrostatic spray apparatus of claim 1, wherein the first electrode is a needle electrode.

4. The electrostatic spray apparatus of claim 1, wherein the second electrode has a conical shape.

5. The electrostatic spray apparatus of claim 1, wherein the first electrode is disposed on a front surface of the electrostatic spray gun, the second electrode is disposed at a first position on the second external surface of the electrostatic spray gun, and a third electrode is disposed at a second position on the second external surface of the electrostatic spray gun.

6. The electrostatic spray apparatus of claim 5, wherein the third electrode is configured to generate a third electric field between the third electrode and a grounded object.

7. The electrostatic spray apparatus of claim 6, wherein the second exterior surface includes a first side surface and a second side surface and second and third electrodes are positioned at generally opposite locations on the first side surface and the second side surface.

8. The electrostatic spray apparatus of claim 1, and further comprising:
a mount block attached to the electrostatic spray gun wherein a joint is formed between the mount block and the electrostatic spray gun and the second electrode is positioned proximate to the joint.

9. The electrostatic spray apparatus of claim 8, wherein a dielectric grease is applied to the joint.

10. The electrostatic spray apparatus of claim 1, wherein each of the electrodes is connected to a charge multiplier unit.

11. The electrostatic spray apparatus of claim 10, wherein the charge multiplier unit is configured to produce a difference in electrical potential between the spray gun and a ground ranging from about 20 kilovolts to about 150 kilovolts.

12. The electrostatic spray apparatus of claim 11, wherein the difference in electrical potential between any of the electrodes and the ground is less than the difference in electrical potential between the spray gun and a ground.

13. The electrostatic spray apparatus of claim 1, wherein a resistor is coupled to any of the electrodes.

14. The electrostatic spray apparatus of claim 1, wherein a controller is configured to shut down the apparatus if a difference in electrical potential between any of the electrodes and ground drops below a threshold value.

15. The electrostatic spray apparatus of claim 1, wherein a controller is configured to shut down the apparatus if a rate of change of a difference in electrical potential between any of the electrodes and ground exceeds a threshold rate of change.

16. An electrostatic spray gun comprising:
a barrel having a front surface, a first side surface, and a second side surface;
a first needle electrode projecting from the front surface of the barrel;
an air cap attached to the front surface of the barrel and configured to dispense paint droplets near the first needle electrode;
a second electrode projecting from the first side surface of the barrel; and
a third electrode projecting from the second side surface of the barrel.

17. The electrostatic spray gun of claim 16, and further comprising:
a charge multiplier unit disposed within the barrel and configured to produce a difference in electrical potential between the spray gun and ground ranging from about 20 kilovolts to about 150 kilovolts.

18. The electrostatic spray gun of claim 17, wherein the second and third electrodes are positioned at generally opposite locations relative to one another along the barrel of the electrostatic spray gun.

19. The electrostatic spray gun of claim 16, wherein the second electrode and third electrode each have a conical shape.

20. The electrostatic spray gun of claim 16, wherein the electrostatic spray gun is an automatic electrostatic spray gun.
